(19) United States
(12) Patent Application Publication
(10) Pub. No.: US 2008/0024735 A1
(43) Pub. Date: Jan. 31, 2008

(54) Rear Projection Display Device

(76) Inventors: Shinya Kanagawa, Chiba (JP); Hiroto Yamasaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/751,386

(22) Filed: May 21, 2007

(30) Foreign Application Priority Data
May 31, 2006 (JP) 2006-152426

(51) Int. Cl. G03B 21/28

(52) U.S. Cl. 353/77

(57) ABSTRACT

Disclosed herein is a rear projection display device including a video image projection unit, a quadrilateral mirror for reflecting video image light emerging from the video image projection unit, a transmission screen onto which the video image light reflected by the mirror is projected from the rear side thereof, and a back cover for covering the rear side of the transmission screen; the back cover having a mirror holding structure for holding the four sides of the mirror along the inner surface of the back cover; the mirror holding structure including a mirror holder as a separate member fixed to the back cover for holding the upper side of the mirror, a first holding portion integral with the back cover for holding the lower side of the mirror, and a second holding portion integral with the back cover for holding the right and left sides of the mirror.

### CROSS REFERENCES TO RELATED APPLICATIONS

The present invention contains subject matter related to Japanese Patent Application JP 2006-152426 filed in the Japan Patent Office on May 31, 2006, the entire contents of which being incorporated herein by reference.

### BACKGROUND OF THE INVENTION

1. Field of the Invention

The present invention relates to a rear projection display device such that video image light emerging from a video image projection unit is reflected by a mirror and next projected onto a transmission screen from the rear side thereof, and more particularly to a holding structure for the mirror in the rear projection display device.

2. Description of the Related Art

A rear projection display device is in actual use as a kind of video image display device in related art. As disclosed in Japanese Patent Laid-open No. Hei 5-313249, such a rear projection display device has a body, a transmission screen provided on the front surface of the body, a video image projection unit provided at a lower portion of the body, and a mirror for reflecting video image light emerging from the video image projection unit and projecting the reflected video image light onto the transmission screen from the rear side thereof.

As shown in Japanese Patent Laid-open No. Hei 9-9185, the mirror for reflecting the video image light is held to the inner surface of a back cover for covering the rear side of the transmission screen. The mirror has a quadrilateral shape, and the four sides of the mirror are held to the back cover. In related art, the lower side of the mirror is held by a holding portion integral with the back cover, and the upper side and the right and left sides of the mirror are held by a plurality of mirror holders as separate members fixed by screws to the back cover.

### SUMMARY OF THE INVENTION

However, such a mirror holding structure has the following problems. A cost for the plural mirror holders as separate members for holding the mirror and a cost for the screws for mounting these mirror holders to the back cover are large to cause an increase in parts cost. Further, a high cost is also required for the fabrication of a mold for forming these mirror holders, causing an increase in mold cost.

Further, since the number of parts including the mirror holders and the screws is large, the number of man-hours for the mounting of the mirror holders and the screwing of the mirror holders is also large. Further, a mounting error occurs between the back cover and each mirror holder, so that the accuracy of mounting of the mirror is prone to become lowered and the strength of mounting portions for the mirror holders as separate members may not be sufficiently ensured, causing the risk of cracking in the mirror.

According to an embodiment of the present invention, it is desirable to provide a rear projection display device which can reduce a parts cost and mold cost for holding the mirror.

According to another embodiment of the present invention, it is desirable to provide a rear projection display device which can reduce the number of parts and the number of man-hours for assembly.

According to yet another embodiment of the present invention, it is desirable to provide a rear projection display device which can improve a mirror mounting accuracy and a mirror holding strength.

According to the embodiments of the present invention, there is provided a rear projection display device including a video image projection unit, a quadrilateral mirror for reflecting video image light emerging from the video image projection unit, a transmission screen onto which the video image light reflected by the mirror is projected from the rear side thereof, and a back cover for covering the rear side of the transmission screen; the back cover having a mirror holding structure for holding the four sides of the mirror along the inner surface of the back cover; the mirror holding structure including a mirror holder as a separate member fixed to the back cover for holding the upper side of the mirror, a first holding portion integral with the back cover for holding the lower side of the mirror, and a second holding portion integral with the back cover for holding the right and left sides of the mirror.

The rear projection display device according to the embodiments of the present invention can exhibit the following effects by adopting the above-mentioned mirror holding structure in comparison with the related art. In the rear projection display device according to the present invention, the right and left sides of the mirror are held by the second holding portion integral with the back cover. Accordingly, the right and left mirror holders used in the related art are not required in the present invention. As a result, the cost for the right and left mirror holders and the cost for the screws for mounting these mirror holders to the back cover are not required, thereby reducing a parts cost. Furthermore, the fabrication of a mold for forming the right and left mirror holders is not required, thereby reducing a mold cost.

Thus, the number of parts can be reduced by eliminating the right and left mirror holders and the associated screws, so that the number of man-hours for the mounting of the right and left mirror holders and the screwing of these mirror holders can be reduced. Further, since the second holding portion for holding the right and left sides of the mirror is integral with the back cover, the accuracy of mounting of the mirror can be improved and the strength of the second holding portion can be sufficiently ensured, thereby reducing the risk of cracking in the mirror.

Other features of the invention will be more fully understood from the following detailed description and appended claims when taken with the accompanying drawings.

### BRIEF DESCRIPTION OF THE DRAWINGS

FIG. 1 is a vertical sectional side view showing the general configuration of a rear projection display device according to the present invention;

FIG. 2 is a front elevation of a back cover, showing the inside structure thereof;

FIG. 3 is a view similar to FIG. 2, showing a condition where a mirror is mounted to the inside of the back cover;

FIG. 4 is a vertical sectional view showing a holding structure for the upper side of the mirror;

FIG. 5 is a vertical sectional view showing a holding structure for the lower side of the mirror;

FIG. 6 is a horizontal sectional view showing a holding structure for the left side of the mirror;

FIG. 7 is a horizontal sectional view showing the structure of a mold for forming the back cover; and

FIG. 8 is a horizontal sectional view showing the shape of the back cover.

### DETAILED DESCRIPTION OF THE PREFERRED EMBODIMENTS

The preferred embodiments of the present invention will now be described in detail with reference to the drawings.

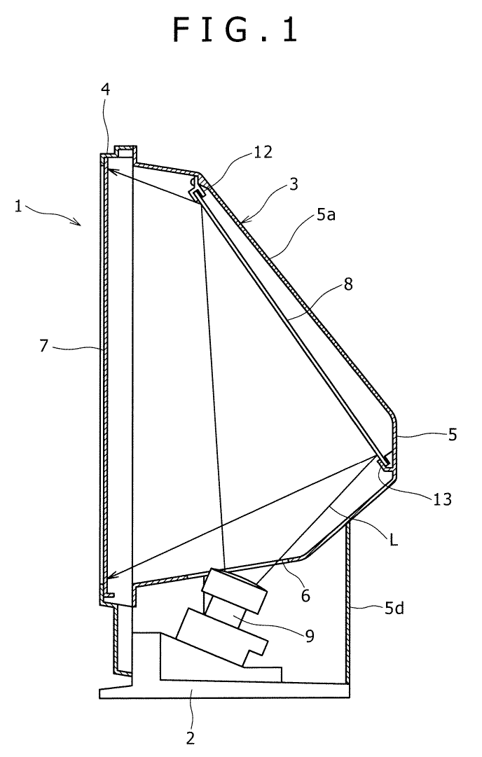

FIG. 1 is a vertical sectional side view showing the general configuration of a rear projection display device 1 according to the present invention.

The rear projection display device 1 includes a base 2 and a housing 3 supported to the base 2. The housing 3 includes a front bezel 4 for holding a transmission screen 7 in its vertical position and a back cover 5 for covering the rear side of the transmission screen 7. The back cover 5 has an inclined rear portion 5a, and a mirror 8 is held in its inclined position to the inside of the inclined rear portion 5a of the back cover 5. A video image projection unit 9 is mounted on the base 2, and video image light L emerging from the video image projection unit 9 is allowed to pass through a light passage hole 6 of the back cover 5 to enter the housing 3. The video image light L is next reflected by the mirror 8 and projected onto the transmission screen 7 from the rear side thereof. The video image projection unit 9 is covered with a lower back cover 5d projecting downward from the back cover 5.

The present invention relates to a holding structure for the mirror 8 in the rear projection display device 1.

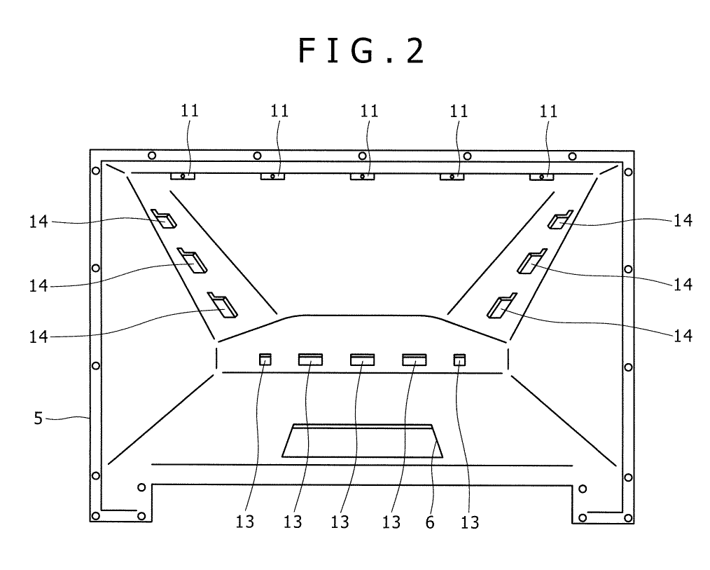

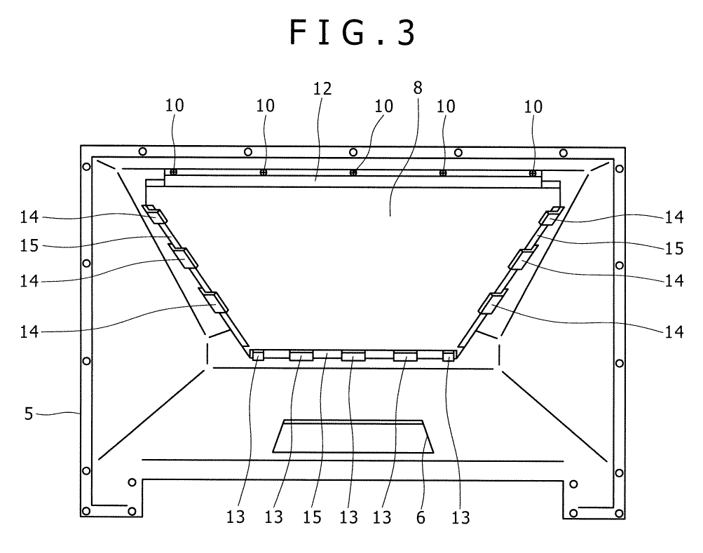

FIG. 2 is a front elevation of the back cover 5, showing the inside structure thereof, and FIG. 3 is a view similar to FIG. 2, showing a condition where the mirror 8 is mounted to the inside of the back cover 5. The mirror 8 is composed of a glass plate and a reflecting film formed on the glass plate by vapor deposition. As shown in FIG. 3, the mirror 8 is quadrilateral in shape, more specifically, inverted trapezoidal in shape in this preferred embodiment, and the four sides of the mirror 8 are held to the back cover 5. More specifically, the upper side of the mirror 8 is held through a mirror holder 12 as a separate member to the back cover 5. The mirror holder 12 is fixed to the back cover 5 by means of screws 10. The lower side of the mirror 8 is held to a plurality of hooklike holding portions 13 integral with the back cover 5. Similarly, the right and left sides of the mirror 8 are held to a plurality of hooklike holding portions 14 integral with the back cover 5.

Since the mirror 8 has an inverted trapezoidal shape, the mirror 8 can be easily held to the hooklike holding portions 13 and 14 of the back cover 5 so as to be inserted into the hooklike holding portions 13 and 14 from a position slightly above a predetermined mounting position. In the condition that the mirror 8 is held to the hooklike holding portions 13 and 14, the mirror holder 12 is fixed to a plurality of fixing portions 11 of the back cover 5 by means of the screws 10 so as to hold the upper side of the mirror 8. Thus, the mirror 8 can be reliably mounted to the back cover 5 at the predetermined mounting position without a possibility of falling from the back cover 5.

Further, a protective frame 15 is fitted to each of the four sides of the mirror 8 to be held to the mirror holder 12 and the hooklike holding portions 13 and 14. The protective frame 15 is formed of resin having good slidability, such as HDPE. Thus, the protective frame 15 functions to reduce the friction between the mirror 8 and the mirror holder 12 and the friction between the mirror 8 and the hooklike holding portions 13 and 14, thereby preventing the generation of resin dust from the mirror holder 12 and the hooklike holding portions 13 and 14.

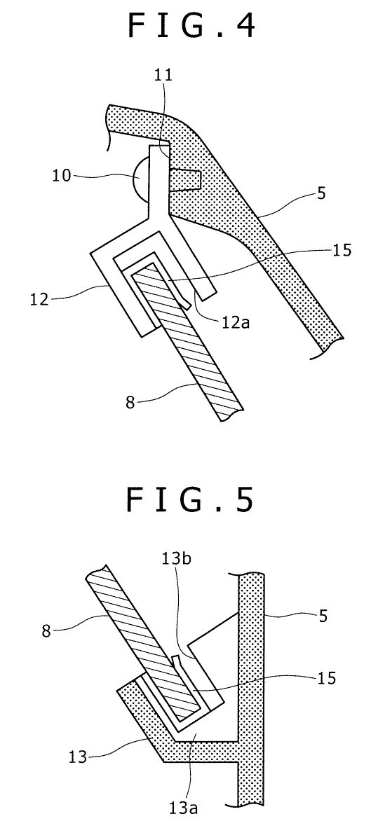

The holding structure for each side of the mirror 8 mounted to the back cover 5 as mentioned above will now be described in more detail with reference to FIGS. 4 to 6.

FIG. 4 is a vertical sectional view showing the holding structure for the upper side of the mirror 8. As shown in FIG. 4, the upper side of the mirror 8 is held by the mirror holder 12 fixed to the back cover 5 by means of the screws 10. The mirror holder 12 is formed of resin. The mirror holder 12 has a U-shaped groove 12a for holding the upper side of the mirror 8. A slight clearance of about 2 mm is defined between the mirror 8 and the inner surface of the U-shaped groove 12a of the mirror holder 12. Owing to the inclined position of the mirror 8, the mirror 8 is kept in abutment against the inner surface of the U-shaped groove 12a of the mirror holder 12 by the own weight of the mirror 8.

FIG. 5 is a vertical sectional view showing the holding structure for the lower side of the mirror 8. As shown in FIG. 5, each hooklike holding portion 13 is formed integrally with the back cover 5 so as to project frontward from the inner surface of the back cover 5 and to extend obliquely upward. The back cover 5 is formed of resin. Each holding portion 13 is integrally formed with a rib 13a having a recess 13b for holding the lower side of the mirror 8. A slight clearance of about 2 mm is defined between the mirror 8 and the inner surface of the recess 13b of the rib 13a. Owing to the inclined position of the mirror 8, the mirror 8 is kept in abutment against the inner surface of the recess 13b of the rib 13a by the own weight of the mirror 8.

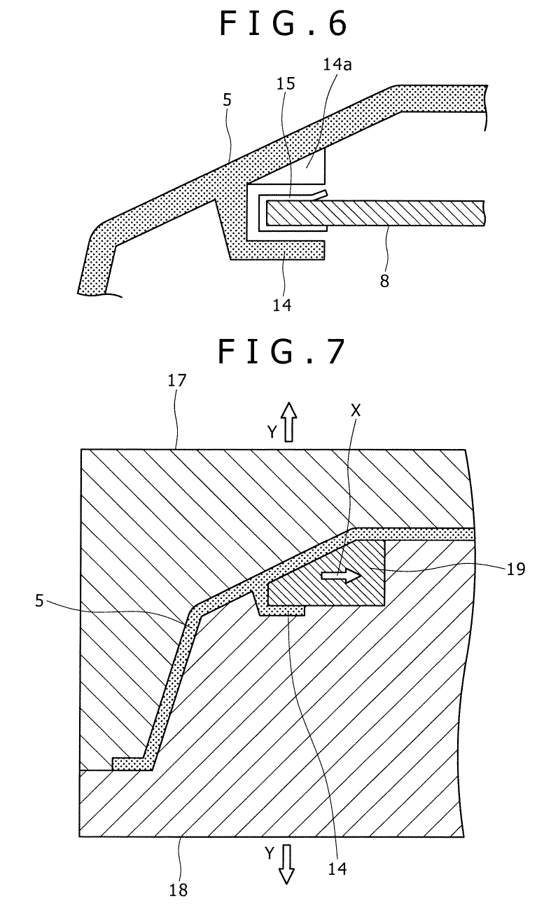

FIG. 6 is a horizontal sectional view showing the holding structure for the left side of the mirror 8. While the holding structure for only the left side of the mirror 8 is shown in FIG. 6, the holding structure for the right side of the mirror 8 is formed similarly in symmetry with the holding structure for the left side of the mirror 8. As shown in FIG. 6, each hooklike holding portion 14 is formed integrally with the back cover 5 so as to project frontward from the inner surface of the back cover 5 and to extend horizontally. Further, a rib 14a is formed on the inner surface of the back cover 5 so as to correspond to each holding portion 14. Each of the right and left sides of the mirror 8 is held between each holding portion 14 and the corresponding rib 14a. A slight clearance of about 2 mm is defined between the mirror 8 and each holding portion 14 and between the mirror 8 and each rib 14a. That is, the mirror 8 is usually held in the condition where it is in noncontact with each holding portion 14 and each rib 14a.

The back cover 5 having such a holding structure for the mirror 8 is formed by using a mold having a slide member as shown in FIG. 7. More specifically, this mold includes a cavity member 17 and a core member 18 for cooperatively forming a body portion of the back cover 5, and further includes a slide member 19 adapted to be released in a direction (X direction) perpendicular to a direction (Y direction) of releasing the cavity member 17 and the core member 18. Each holding portion 14 is formed between the core member 18 and the slide member 19. While the mold for forming each holding portion 14 for holding the left side of the mirror 8 is shown in FIG. 7, each holding portion 14 for holding the right side of the mirror 8 and each holding portion 13 for holding the lower side of the mirror 8 can be formed by using a similar molding structure.

Thus, the hooklike holding portions 13 and 14 can be simply formed integrally with the back cover 5 by using the mold having the slide member 19.

While the core member 18 and the slide member 19 are schematically shown in FIG. 7, it is needless to say that an actual structure of these mold members 18 and 19 is provided by a core slide technique in related art.

The rear projection display device 1 according to this preferred embodiment can exhibit the following effects by adopting the above-mentioned mirror holding structure in comparison with the related art.

In the rear projection display device in related art, the right and left sides of the mirror are held by the respective mirror holders as separate members as mentioned above. To the contrary, in the rear projection display device 1 according to the present invention, the right and left sides of the mirror 8 are held by the holding portions 14 integral with the back cover 5. Accordingly, the right and left mirror holders used in related art are not required in the present invention. As a result, the cost for the right and left mirror holders and the cost for the screws for mounting these mirror holders to the back cover are not required, thereby reducing a parts cost. Furthermore, the fabrication of a mold for forming the right and left mirror holders is not required, thereby also reducing a mold cost.

Thus, the number of parts can be reduced by eliminating the right and left mirror holders and the associated screws, so that the number of man-hours for the mounting of the right and left mirror holders and the screwing of these mirror holders can be reduced.

Further, since the holding portions 14 for holding the right and left sides of the mirror 8 are integral with the back cover 5, the accuracy of mounting of the mirror 8 can be improved and the strength of each holding portion 14 can be sufficiently ensured, thereby reducing the risk of cracking in the mirror 8.

As shown in FIG. 6, each holding portion 14 for holding the right and left sides of the mirror 8 is usually kept in noncontact with the mirror 8, and when the mirror 8 becomes warped, the mirror 8 comes into contact with each holding portion 14.

Accordingly, in a usual condition, the mirror 8 is held along its upper and lower sides to the mirror holder 12 and the holding portions 13, respectively, so that the mirror 8 can be stably mounted to the back cover 5 without an undesired play. Further, in the event that the mirror 8 becomes warped because of shock or the like during transportation, the mirror 8 is firmly held along its four sides to the mirror holder 12 and the hooklike holding portions 13 and 14, so that the mirror 8 can be reliably mounted to the back cover 5 without a possibility of falling from the back cover 5.

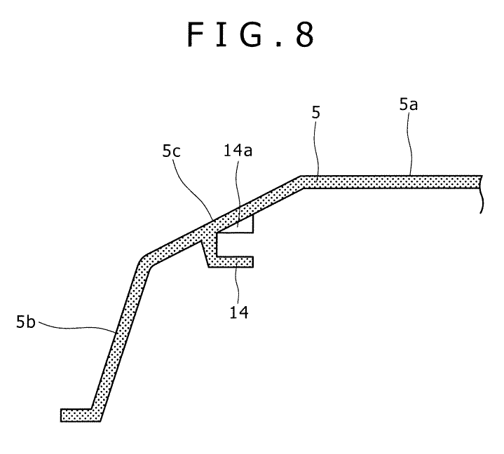

Further, as shown in FIG. 8, the back cover 5 is formed with a chamfered portion 5c at which the holding portions 14 for holding the left side of the mirror 8 are formed (i.e., a corner portion between the rear portion 5a and the left side portion 5b of the back cover 5). Although not shown, a similar chamfered portion is also formed at another corner portion between the rear portion 5a and the right side portion 5b of the back cover 5 where the holding portions 14 for holding the right side of the mirror 8 are formed.

With this configuration, the following effect can be exhibited. In the case of stacking many back covers 5 in manufacturing the rear projection display devices 1 according to this preferred embodiment, the chamfered portions 5c of the lower back cover 5 function as escape portions for the holding portions 14 of the upper back cover 5. Thus, it is possible to prevent the abutment of the holding portions 14 of the upper back cover 5 against the lower back cover 5, thereby effectively preventing the damage to the holding portions 14.

While a specific preferred embodiment of the present invention has been described, it should be noted that the present invention is not limited to this preferred embodiment, but other various preferred embodiments may be adopted.

While the invention has been described with reference to specific embodiments, the description is illustrative and is not to be construed as limiting the scope of the invention. Various modifications and changes may occur to those skilled in the art without departing from the spirit and scope of the invention as defined by the appended claims.

What is claimed is:

1. A rear projection display device comprising:
a video image projection unit;
a quadrilateral mirror configured to reflect video image light emerging from said video image projection unit;
a transmission screen onto which said video image light reflected by said mirror is projected from the rear side thereof; and
a back cover configured to cover the rear side of said transmission screen;
said back cover having a mirror holding structure configured to hold the four sides of said mirror along the inner surface of said back cover;
said mirror holding structure including
a mirror holder as a separate member fixed to said back cover configured to hold the upper side of said mirror,
a first holding portion integral with said back cover configured to hold the lower side of said mirror, and
a second holding portion integral with said back cover configured to hold the right and left sides of said mirror.

2. The rear projection display device according to claim 1, wherein said second holding portion configured to hold the right and left sides of said mirror is usually kept in noncontact with said mirror, and in the case that said mirror becomes warped, said second holding portion comes into contact with said mirror.

3. The rear projection display device according to claim 1, wherein said back cover is chamfered at a portion where said second holding portion configured to hold the right and left sides of said mirror is formed.

4. A rear projection display device comprising:
a video image projection unit;
a mirror configured to reflect video image light emerging from said video image projection unit;
a transmission screen onto which said video image light reflected by said mirror is projected from the rear side thereof; and
a back cover disposed at the rear side of said transmission screen;
said back cover having a mirror holding structure configured to hold said mirror along the inner surface of said back cover;
said mirror holding structure including a holding portion integral with said back cover configured to hold at least the right and left sides of said mirror, and
said back cover being chamfered at a portion where said holding portion configured to hold the right and left sides of said mirror is formed.
